(19) United States
(12) Patent Application Publication
(10) Pub. No.: US 2019/0375347 A1
(43) Pub. Date: Dec. 12, 2019

(54) PROTECTOR FOR WIRE HARNESS

(71) Applicant: SUMITOMO WIRING SYSTEMS, LTD., Mie (JP)

(72) Inventor: Hisashi KOTANI, Mie (JP)

(73) Assignees: SUMITOMO WIRING SYSTEMS, LTD., Mie (JP); SUMITOMO WIRING SYSTEMS, LTD., Mie (JP)

(21) Appl. No.: 16/061,452

(22) PCT Filed: Dec. 7, 2016
(86) PCT No.: PCT/JP2016/086347

§ 371 Date: Jun. 12, 2018

(30) Foreign Application Priority Data
Dec. 21, 2015 (JP) 2015-249112

(51) Int. Cl. B60R 16/02; H02G 3/04

(52) U.S. Cl. CPC B60R 16/0215; H02G 3/0481

(57) ABSTRACT

A protector having an insertion path of a branch wire which branches from a trunk wire of a wire harness where, when the branch wire is not inserted into the branch wire insertion path, the branch wire insertion path can be closed. A closing plate is rotatably suspended, via a hinge, on a bottom surface of a lid of the branch wire insertion path which branches from a trunk wire insertion path, and when the branch wire is inserted into the branch wire insertion path, the branch wire kicks up the closing plate and is extracted sideways, and the closing plate is oriented downward when there is no branch wire and closes the branch wire insertion path.

### FIELD OF THE INVENTION

The present invention relates to a protector for a wire harness, and particularly has a structure capable of accommodating the presence of a branch wire that branches from a trunk wire of a wire harness.

### BACKGROUND OF THE INVENTION

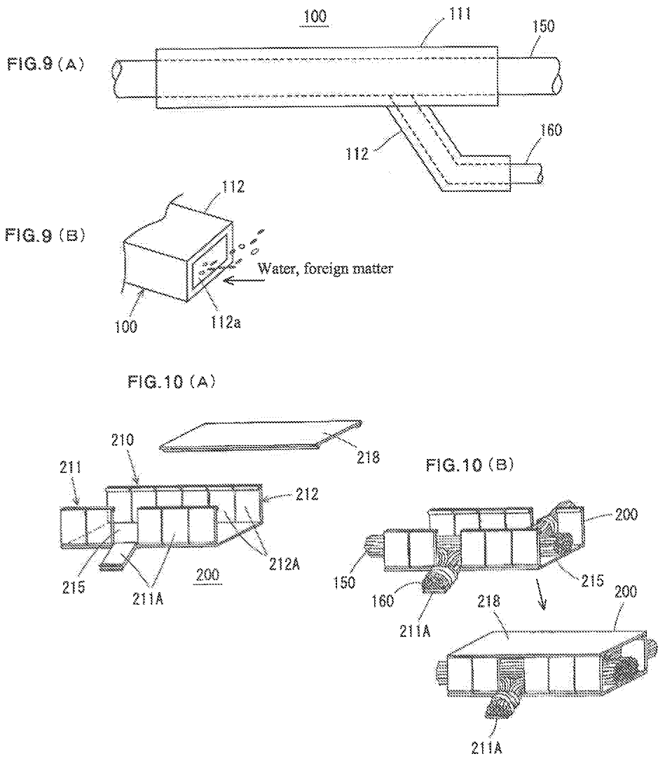

A wire harness routed in a vehicle such as an automobile is sheathed by a molded resin protector in an area where a path must be regulated and where the wire harness must be protected. In a protector of this type, when there is a branch wire that branches from a trunk wire of a wire harness and the branch wire must be protected by the protector similar to the trunk wire, a protector 100 is provided with a trunk wire insertion portion 111 where a trunk wire 150 of the wire harness is inserted and with a branch wire insertion portion 112 where a branch wire 160 is inserted as illustrated in FIG. 9.

In the wire harness sheathed by the protector 100, the branch wire 160 may not be branched from the trunk wire due to differences in vehicle type and grade, and the branch wire 160 may not be wired to the branch wire insertion portion 112 of the protector 100. In such a case, an outlet 112a of the branch wire insertion portion 112 is empty, and so foreign matter such as dust and water can easily enter inside the protector 100 and may have a negative influence on the trunk wire 150 which is inserted into the protector 100. In order to solve this issue, a protector without a branch portion for a branch wire may be provided separately. However, when another type of protector is provided based on the presence of the branch wire, the number of components increases, thus increasing costs.

Conventionally, in Japanese Patent Laid-open Publication No. H08-251754, the applicant provides a protector 200 as illustrated in FIG. 10. The protector 200 is configured to be able to correspond to a design change of the wire harness, and is configured with both side walls 211 and 212 of a main body 210 divided into a plurality of side walls 211A and 212A. Each of these divided side walls 211A and 212A stands independently so as to be foldable outward from a bottom wall 215 and the side walls 211A and 212A which correspond to a location where the branch wire 160 branches from the trunk wire 150 of the wire harness are selected and folded outward and the branch wire 160 is extracted from the protector 200.

### RELATED ART

### Patent Literature

Patent Literature 1: Japanese Patent Laid-open Publication No. H08-251754

### SUMMARY OF THE INVENTION

### Problems to be Solved by the Invention

When the protector 200 illustrated in FIG. 10 is used, it is not necessary to fold the side walls 211A and 212A outwardly in a case where there is no branch wire branched from the trunk wire. However, when the branch wire 160 is extracted by selecting and folding down the necessary side walls 211A and 212A needed, only a bottom surface of the branch wire 160 is supported by the lowered side wall so an entire circumference of the branch wire 160 is not protected. Therefore, the protector 200 cannot be used when interference from outside members exists in the surrounding area. Moreover, in order to hold the plurality of divided side walls 211A and 212A of both side walls in standing positions, a lid 218 must be engaged with the side walls 211A and 212A, so there is an issue that work becomes troublesome and the structure is complicated. Furthermore, when a wire bundle is divided at a terminal side of the trunk wire and separated into the branch wire, for example, the protector 200 cannot be applied.

The present invention is conceived in light of the above-noted issues, and provides a protector that can prevent water exposure and entry of foreign matter from the outlet of the branch portion when there is no branch wire passing through the branch portion.

### Means for Solving the Problems

In order to resolve the above-noted issues, the present invention provides a wire harness protector configured by a main body and a lid closing an upper opening of the main body, the main body being provided with a branch wire insertion path continuous from a trunk wire insertion path, and the trunk wire insertion path and the branch wire insertion path having side walls standing from two ends of a bottom wall in a width direction. The wire harness protector is configured such that, a closing plate is provided projecting from a bottom surface of the lid so as to rotate, via a hinge, between a downward direction and a sideways direction along the bottom surface of the lid, at the branch wire insertion path where a branch wire may be present that is branched from a trunk wire of a wire harness inserted through the trunk wire insertion path, the branch wire being inserted through the branch wire insertion path; and the branch wire inserted into the branch wire insertion path is extracted sideways by kicking up the closing plate; and the closing plate is oriented downward when there is no branch wire and closes the branch wire insertion path.

Depending on vehicle type and class, a branch wire branched from the trunk wire of the wire harness routed in the vehicles may or may not exist. When the closing plate is attached to the lid of the branch wire insertion path of the wire harness protector so as to be able to open and close freely, the closing plate closes the branch wire insertion path when there is no branch wire and water and foreign matter can be prevented from entering the outlet. In addition, when there is a branch wire, the closing plate can be kicked up by the branch wire. Therefore, there is no need to provide separate protectors based on the presence of the branch wire, so the number of components can be reduced. When the branch wire branched from the trunk wire is always present regardless of the type and class of the vehicle, the closing plate is not provided to the lid of the branch wire insertion path.

Preferably, in the protector of the present invention, the lid is provided separately from the main body and after inserting the wire harness into the main body, the lid and the main body are lock-joined by covering the main body with the lid; and whereas the closing plate is a rectangular flat plate that can fully close across the branch wire insertion path and the thin-walled hinge is provided between a top end of the closing plate and the bottom surface of the lid, pairs of guide frames are respectively provided projecting on inner surfaces of both side walls of the main body, the guide frames holding the closing plate when the closing plate is in a downward, closed position, and top end positions of the pairs of guide frames are positioned away from a top end of the side wall by a gap at least the thickness of the closing plate, and the closing plate is configured to be supported by the guide frames and able to maintain a sideways, open posture. Moreover, one width-direction end of the main body and the lid may be connected via a thin-walled hinge and integrally molded. In this case, the closing plate provided to the lid is rotated toward the main body while in contact with the bottom surface of the lid to close, and the branch wire insertion path can be closed by rotating the closing plate downward in a closed state.

Instead of the closing plate which blocks the branch wire insertion path being sandwiched with the pair of guide frames to hold in position, as described above, an engagement hole where an engagement projection is inserted may be provided to the bottom wall of the main body while the engagement projection is provided to the bottom surface of the closing plate.

The closing plate which opens and closes the branch wire insertion path may be provided at any one of a branch position where the branch wire insertion path branches from the trunk wire, a position of the outlet on a front end, or a middle position therebetween. However, the closing plate is preferably provided near the outlet so that a visual inspection of a status of the closing plate can be performed.

### Effect of the Invention

In the wire harness protector of the present invention, the closing plate is attached to the lid of the branch wire insertion path so as to be able to open and close freely, and therefore, the closing plate closes the branch wire insertion path when there is no branch wire and water and foreign matter can be prevented from entering the outlet. In addition, when there is s branch wire, the closing plate can be kicked up by the branch wire. Therefore, there is no need to provide separate protectors based on the presence of the branch wire, which allows the number of components to be reduced, facilitating cost reduction and component management. In addition, a place where the branch wire may be separated for different uses can be protected and path-regulated by the protector.

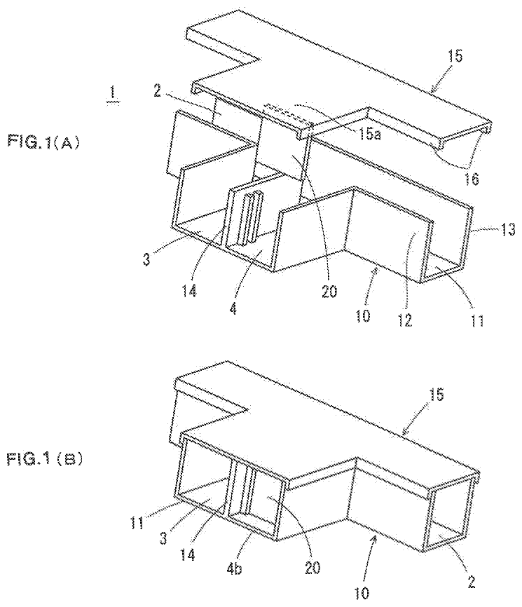

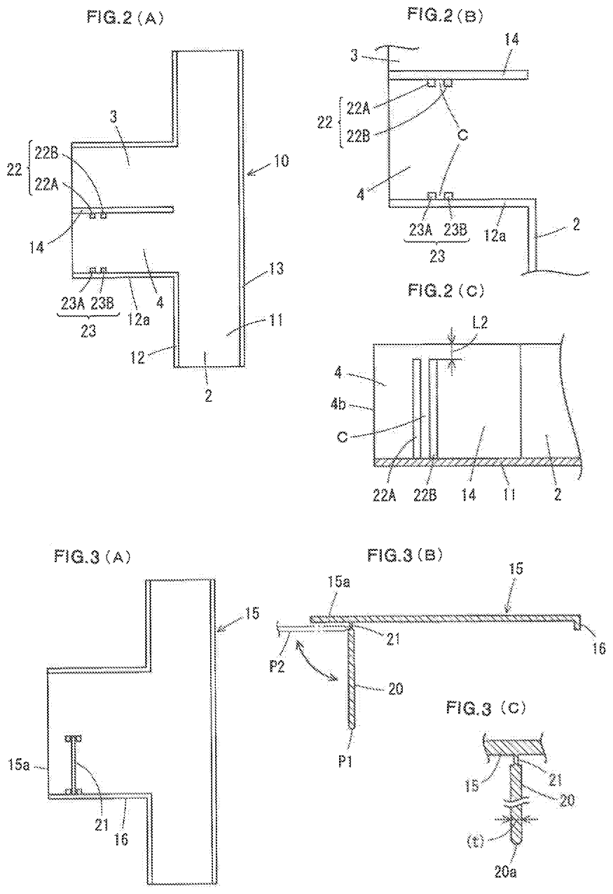

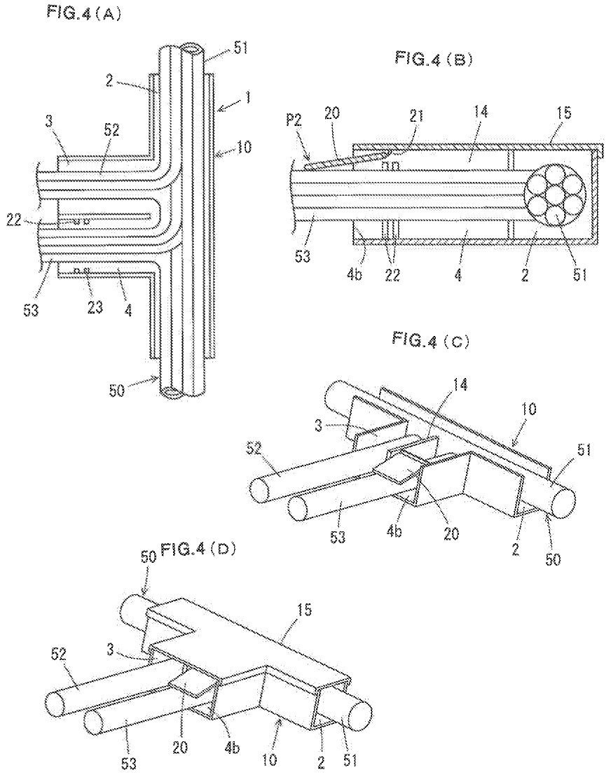

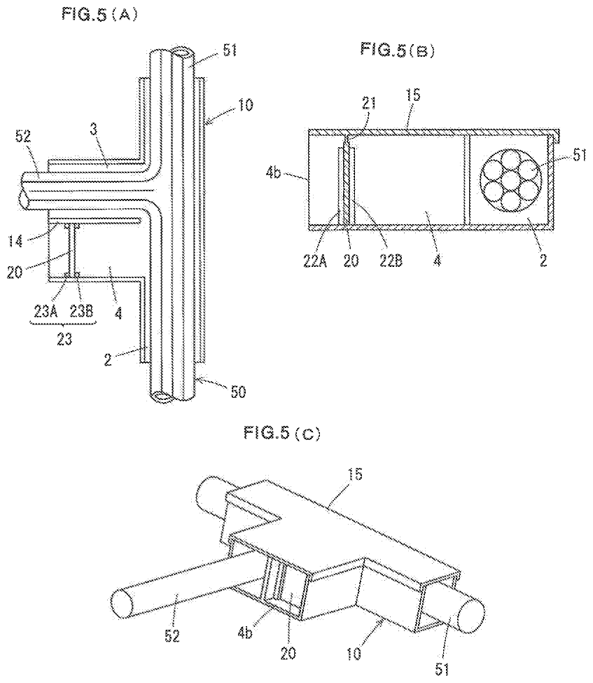

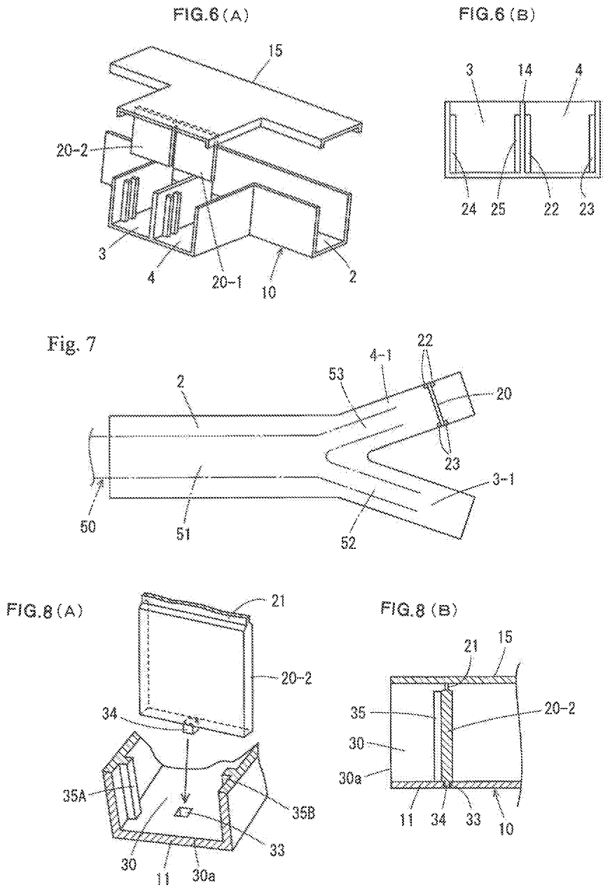

### BRIEF DESCRIPTION OF THE DRAWINGS

[FIG. 1] illustrates a protector of Embodiment 1 according to the present invention, where (A) is an exploded perspective view of a main body and a lid and (B) is a perspective view of a state where the main body and the lid are assembled.

[FIG. 2] illustrates the main body, where (A) is a plan view, (B) is an enlarged plan view of a relevant portion of (A), and (C) is an enlarged cross-sectional view of a relevant portion.

[FIG. 3] illustrates the lid, where (A) is a bottom view, (B) is a cross-sectional view of (A), and (C) is an enlarged cross-sectional view of a relevant portion.

[FIG. 4] illustrates a case where a wire harness having two branch wires is inserted into the protector, where (A) is a plan view where the wire harness is inserted into the main body, (B) is a cross-sectional view of a closing plate being opened by a branch wire, (C) is a perspective view of (B) without the lid, and (D) is a perspective view of the wire harness sheathed by the protector.

[FIG. 5] illustrates a case where a wire harness having one branch wire is inserted into the protector, where (A) is a plan view where the wire harness is inserted into the main body, (B) is a cross-sectional view of (A), and (C) is a perspective view of the wire harness sheathed by the protector.

[FIG 6] illustrates a first modification of Embodiment 1, where (A) is an exploded perspective view of a protector and (B) is a cross-sectional view of (A).

[FIG. 7] is a schematic view of a protector illustrating a second modification of Embodiment 1.

[FIG. 8] illustrates a protector of Embodiment 2 according to the present invention, where (A) is a perspective view of a main portion and (B) is a cross-sectional view of a state where the branch wire insertion path is closed by the closing plate.

[FIG. 9] (A) and (B) show a conventional example.

[FIG. 10] (A) and (B) show another conventional example.

### MODE FOR CARRYING OUT THE INVENTION

In the following, a wire harness protector of the present invention is described with reference to the drawings. FIGS. 1 through 5 illustrate Embodiment 1.

A wire harness protector 1 of Embodiment 1 is configured with a molded resin article and includes a trunk wire insertion path 2 where a trunk wire 51 of a wire harness 50 is inserted (illustrated in FIG. 4) and, contiguously, a first branch wire insertion path 3 and a second branch wire insertion path 4 where two branch wires 52 and 53 pass through from one side of the trunk wire insertion path 2. The protector 1 provided with the trunk wire insertion path 2, the first branch wire insertion path 3, and the second branch wire insertion path 4 is configured by a main body 10 and a lid 15 which are separate components. The main body 10 has a recessed shape in cross-section where side walls 12 and 13 stand from two ends of a bottom wall 11 in a width direction. A dividing wall 14 stands between the first branch wire insertion path 3 and the second branch wire insertion path 4.

After the trunk wire 51 is passed through the trunk wire insertion path 2 enclosed by the bottom wall 11 and side walls 12 and 13 of the main body 10 and the branch wires are inserted into the first and second branch wire insertion paths 3 and 4, an upper opening of the main body 10 is covered and closed by the lid 15, then locked and joined. In other words, a lock claw (not illustrated in the drawings) provided to circumferential walls 16 of the lid 15 is inserted and engaged to a lock frame (not illustrated in the drawings) provided to both side walls 12 and 13 of the main body 10, and is thereby locked and joined.

The first branch wire 52 passing through the first branch wire insertion path 3 is provided to all vehicles in which the wire harness 50 is routed, however, the second branch wire 53 passing through the second branch wire insertion path 4 is provided to a high grade vehicle, but not to a low grade vehicle. Accordingly, there are cases where the second branch wire 53 is passed through the second branch wire insertion path 4 and cases where this is not done. The present embodiment is provided with a mechanism to open/close the second branch wire insertion path 4 in response to the presence of the second branch wire 53.

The opening/closing mechanism of the path is configured with a closing plate 20 and pairs of guide frames 22 (22A and 22B) and 23 (23A and 23B). The closing plate 20 projects, via a thin-walled hinge 21, from a bottom surface of a lid portion 15a positioned as a top wall of the second branch wire insertion path 4. The pairs of guide frames 22 (22A and 22B) and 23 (23A and 23B) project on inner surfaces of the two side walls 14 and 12a of the second branch wire insertion path 4, respectively. The thin-walled hinge 21 and the closing plate 20 are integrally molded with the lid 15 simultaneously. Similarly, the guide frames 22 and 23 are integrally molded with the main body 10 simultaneously.

The position of the opening/closing mechanism which is configured by the closing plate 20 and guide frames 22 and 23 is located near an outlet 4b at a front end of the second branch wire insertion path 4 and is enclosed by the bottom wall 11, side wall 12, and dividing wall 14. The closing plate 20 is a flat plate shape which closes across the second branch wire insertion path 4 and a bottom edge 20a is in a circular arced shape, as shown in FIG. 3 (C), so as not to damage an electric wire when making contact with the second branch wire 53.

The closing plate 20 provided to the lid 15 is provided such that the total length of an upper edge of the closing plate 20 is contiguous, via the thin-walled hinge 21, to a bottom surface of the lid 15. As shown in FIG. 3 (B), the closing plate 20 can be rotatably displaced to a closed position P1 where the closing plate 20 is in a downward vertical posture and an open position P2 where the closing plate 20 is in a sideways posture along the bottom surface of the lid 15. In the open position P2 where the closing plate 20 is sideways, as shown in FIG. 4 (D), the closing plate 20 is configured to project outward from the outlet side of the lid 15.

On the other hand, on the inner surface of the side wall 12 of the main body 10, the pair of guide frames 23 (23A and 23B) having a gap C to hold the closing plate 20 project in a height direction from a boundary position with the bottom wall 11 to a position a dimension L2 away from a side wall top edge. The dimension L2 is almost double (2t) a thickness (t) of the closing plate 20. Similarly, the pair of guide frames 22 (22A and 22B) is provided, with a gap therebetween, at the position opposite on the second internal surface of the dividing wall 14.

When the protector 1 having the above-described configuration is used, in a case where the first branch wire 52 and the second branch wire 53 are branched from the trunk wire 51 of the wire harness 50, the trunk wire 51 passes through the trunk wire insertion path 2 of the main body 10, the first branch wire 52 branched from the trunk wire 51 passes through the first branch wire insertion path 3, and the second branch wire 53 passes through the second branch wire insertion path 4, as shown in FIG. 4 (A). The wire harness 50 is inserted into the main body 10 from the upper opening of the main body 10.

After passing the wire harness into the main body 10, the upper opening is closed with the lid 15, as shown in FIG. 4 (B), then the main body 10 and the lid 15 are locked and joined. In that case, the closing plate 20 is provided to the bottom surface of the lid 15 which occupies an upper surface position on the second branch wire insertion path 4, and therefore, in a process of attaching the lid 15 to the main body 10, when a bottom end of the closing plate 20 which is suspended downward from the lid 15 contacts a top surface of the second branch wire 53, the closing plate 20 is kicked up sideways on the thin-walled hinge 21. The closing plate 20 facing sideways is in a state where base end portions on the hinge side on both ends of the closing plate 20 in the width direction are placed on top surfaces of the guide frames 22 and 23 and the closing plate 20 is held in an open posture with the plate oriented sideways. In this way, in a state where the closing plate 20 is rotated and displaced to the open position P2, the lid 15 closes the upper opening of the main body 10, then is locked and joined.

On the other hand, when only the first branch wire 52 is branched from the trunk wire 51 of the wire harness 50 and no second branch wire 53 exists, as shown in FIG. 5 (A), the second branch wire 53 does not pass through the second branch wire insertion path 4 of the main body 10 of the protector 1. In this case, as shown in FIG. 5 (B), when covering the main body 10 with the lid 15, the bottom end of both width-direction ends of the closing plate 20, which is suspended from the bottom surface of the lid 15, is inserted into the gap between the pair of guide frames 22A and 22B of the dividing wall 14 of the main body 10 and into the gap between the pair of guide frames 23A and 23B of the side wall 12 to lower the closing plate 20. When the bottom end of the closing plate 20 comes into contact with the surface of the bottom wall 11, the second branch wire insertion path 4 is closed by the closing plate 20. In this state, the lid 15 and main body 10 are locked and joined.

As described above, when the second branch wire 53 does not pass through the second branch wire insertion path 4, during an operation of covering the main body 10 with the lid 15, the second branch wire insertion path 4 is closed with the closing plate 20 which is provided to the lid 15. Because the closing plate 20 is close to the outlet 4b of the second branch wire insertion path 4, the outlet 4b is in a closed state, which allows water exposure and entry of foreign matter to the outlet 4b to be prevented. Therefore, an adverse effect on the wire harness 50 inserted inside the protector 1 can be prevented.

FIGS. 6 (A) and (B) illustrate a first modification of Embodiment 1. In a protector of the first modification, both the first branch wire insertion path 3 and the second branch wire insertion path 4 are provided with closing plates 20-1 and 20-2, which are path opening/closing mechanisms, on the lid 15. Similar to the second branch wire insertion path 4, pairs of guide frames 24 and 25 are provided on the inner surface of both side walls of the first branch wire insertion path 3 of the main body 10. As described above, when the path opening/closing mechanism is provided to the first and second branch wire insertion paths 3 and 4 respectively, the same protector can accommodate even cases where there is no first branch wire passing through the first branch wire insertion path 3.

FIG. 7 illustrates a second modification. In a protector of the second modification, a first branch wire insertion path 3-1 and a second branch wire insertion path 4-1 which are branched into two are provided toward the outlet at one end of the trunk wire insertion path 2 in a length direction and the lid is also shaped to correspond with the main body. The closing plate 20 is provided, via the thin-walled hinge, to the bottom surface of the lid which is the top surface of the second branch wire insertion path 4-1, and the pairs of guide frames 22 and 23 are provided at corresponding positions to the inner surface of both side walls of the second branch wire insertion path 4-1. With the above-mentioned configuration, it is possible to accommodate a case where the front end of the trunk wire 51 of the wire harness 50 is branched into two to provide the first branch wire 52 and the second branch wire 53, as well as a case where only the first branch wire 52 is provided.

FIGS. 8 (A) and (B) illustrate a protector of Embodiment 2. The protector is configured with the main body 10 and the lid 15, similar to the protector of Embodiment 1, and a single branch wire insertion path 30 is branched from a side wall of a trunk wire insertion path, and the protector can accommodate both cases where a branch wire branched from a trunk wire of the wire harness passes through the branch wire insertion path 30, as well as cases where no branch wire passes through the branch wire insertion path 30.

In a vicinity of an outlet 30a of the branch wire insertion path 30, an engagement hole 33 is provided to the bottom wall 11 of the main body 10 and single positioning frames 35A and 35B are provided to both side walls 12 and 13. The lid 15 has the closing plate 20-2 suspended via the thin-walled hinge 21 similar to Embodiment 1 and an engagement projection 34 inserting into the engagement hole 33 is provided to a bottom end of the closing plate 20-2.

In the protector, when the branch wire passes through the branch wire insertion path 30, the closing plate 20-2 is kicked up by the branch wire and the base end side of both width-direction ends of the closing plate 20-2 is placed on a top surface of the positioning frame 35 (35A and 35B) and occupies the open position oriented sideways. On the other hand, when the branch wire is not present in the branch wire insertion path 30, both width-direction sides of the outlet side surface of the closing plate 20-2 are inserted into the main body 10 along the positioning frames 35A and 35B, whereupon the engagement projection 34 of the bottom end of the closing plate 20-2 is inserted into the engagement hole 33 and the closing plate 20-2 is held in a position where the branch wire insertion path 30 is closed. In this way, water exposure and entry of foreign matter can be prevented by closing the branch wire insertion path 30 with the closing plate 20-2.

### DESCRIPTION OF REFERENCE NUMERAL

1 Protector

2 Trunk wire insertion path

3 First branch wire insertion path

4 Second branch wire insertion path

10 Main body

15 Lid

20 Closing plate

21 Thin-walled hinge

22, 23 Guide frame

50 Wire harness

51 Trunk wire

52 First branch wire

53 Second branch wire

1. A wire harness protector having a main body provided with a branch wire insertion path continuous from a trunk wire insertion path, the trunk wire insertion path and the branch wire insertion path having side walls standing from two ends of a bottom wall in a width direction, and a lid closing an upper opening of the main body,
the wire harness protector including a closing plate projecting from a bottom surface of the lid, the closing plate being configured to rotate, via a hinge, between a downward direction and a sideways direction along the bottom surface of the lid, the closing plate being located at the branch wire insertion path, which is configured to contain a branch wire that is branched from a trunk wire of a wire harness inserted through the trunk wire insertion path,
wherein, when the branch wire is inserted through the branch wire insertion path, the closing plate is extracted sideways by rotating upwards; and, when there is no branch wire in the branch wire insertion path, the closing plate is oriented downward and closes the branch wire insertion path.

2. The wire harness protector according to claim 1, wherein the main body and the lid are separate components, and after inserting the wire harness into the main body, the lid and the main body are lock-joined by covering the main body with the lid,
wherein the closing plate is a rectangular flat plate that can fully close across the branch wire insertion path and the hinge is provided between a top end of the closing plate and the bottom surface of the lid, and
pairs of guide frames respectively project from inner surfaces of both side walls of the main body, the guide frames holding the closing plate when the closing plate is in a downward, closed position, and top end positions of the pairs of guide frames are positioned away from a top end of the side wall by a gap at least the thickness of the closing plate, such that the closing plate is supported by the guide frames in a sideways, open posture.
